(19) United States
(12) Patent Application Publication
(10) Pub. No.: US 2005/0235826 A1
(43) Pub. Date: Oct. 27, 2005

(54) Air separation system using dehydration membrane for pretreatment of compressed air

(75) Inventors: John A. Jensvold, Benicia, CA (US); Frederick L. Coan, Antioch, CA (US)

Correspondence Address: WILLIAM H. EILBERG, THREE BALA PLAZA, SUITE 501 WEST, BALA CYNWYD, PA, 19004, US

(73) Assignee: Generon IGS, Inc.

(21) Appl. No.: 11/101,273

(22) Filed: Apr. 6, 2005

Related U.S. Application Data
(60) Provisional application No. 60/565,949, filed on Apr. 27, 2004.

(51) Int. Cl. B01D 53/22

(52) U.S. Cl. 95/52

(57) ABSTRACT

A system and method for separating air into components uses an air dehydration membrane for removing water vapor from compressed air. Dried compressed air is then directed, from the dehydration membrane, into a gas separation module which may be a membrane system, different from the air dehydration membrane, or a pressure swing adsorption (PSA) system. The air dehydration membrane is made of a hydrophilic polymer having a permeability for water vapor which is greater than its permeability for air, and having low selectivity between oxygen and nitrogen. The air dehydration membrane has a hydrophilic coating, which itself may be a polymer. The coating does not affect the selectivity of the coated dehydration membrane with respect to oxygen and nitrogen, but does increase selectivity of the membrane with respect to water vapor.

### CROSS-REFERENCE TO PRIOR APPLICATION

Priority is claimed from U.S. Provisional Patent Application Ser. No. 60/565,949, filed Apr. 27, 2004.

### BACKGROUND OF THE INVENTION

This invention relates to the field of non-cryogenic separation of air into components, and provides a system wherein a polymeric membrane removes water vapor from compressed air to be separated.

It has been known to use gas permeable membranes, or pressure swing adsorption (PSA) systems, to separate air into components. A typical membrane system produces two output streams, one of which is oxygen-enriched, and the other of which is oxygen-depleted (i.e. mainly nitrogen). A membrane has the inherent advantage that it does not require energy to operate. A membrane system has no moving parts, and thus requires little or no maintenance. A PSA system has similar advantages.

The motive force for the air passing through the gas-separation membrane or PSA system comes from the pressure of the air. To move the air through the system, it is necessary to compress the air, so that the air enters the gas separation membrane, or PSA system, at higher than ambient pressure. Thus, the first step in a membrane-based, or PSA-based, air separation process is to compress ambient air.

One problem arising from the use of compressed air is that, because there is always at least some water vapor in the air before the compression step, the process of compression tends to produce liquid water. The result is that liquid water, and water vapor, become entrained with the compressed air. If the water vapor is not removed, it is likely to condense in the air-separation membrane or PSA unit, and also in the carbon bed used to remove hydrocarbon vapors from the air before it enters the membrane or PSA unit.

One prior art solution to the above-described problem is to use a cryogenic system, which refrigerates the air so as to liquefy as much water as possible. The water is preferably cooled to a temperature that is higher than the dewpoint of the air. The air is therefore in a superheated condition, wherein it has a dewpoint slightly above freezing, so that as long as the air temperature remains above the dewpoint, no liquid water will form. A cryogenic system has the obvious disadvantage that it requires the transportation and storage of cryogenic liquids, which inherently consumes energy. Also, the cryogenic liquids must be periodically replenished. And the system requires periodic maintenance.

Another approach is to provide superheat to the compressed gas. This approach is also expensive, and requires that the air separation system operate at elevated temperatures that are likely to reduce the efficiency and durability of the air separation system. Superheated systems often require the air separation modules to operate at 20° C. higher than ambient temperature. In hot locations, the ambient temperature may be over 45° C., requiring that the modules operate at 65° C. or higher, to avoid liquid water contamination problems.

Polymeric membranes have been used for separating water from air. However, the membrane dryers of the prior art have been less efficient than other drying methods of the prior art. In general, prior art membranes have shown an efficiency of about 75%, compared with efficiencies of up to about 98% with some prior art techniques.

The present invention therefore provides a membrane-based or PSA-based air separation system and method in which water and water vapor are removed from the compressed air flowing to the membrane or PSA unit, the water vapor removal being performed by an air dehydration membrane. The air dehydration membrane disclosed herein has substantially improved efficiency in removing water from compressed air.

### SUMMARY OF THE INVENTION

The present invention comprises a method and apparatus for separating air into its primary components, namely nitrogen and oxygen. In one basic form, the invention uses two distinct membranes connected in series, one for removing water vapor from the compressed air to be separated, and another for performing the separation of the dried compressed air. In another basic form, the invention uses a membrane for dehydration of the compressed air, followed by a pressure swing adsorption (PSA) system for separating the air into components.

The module containing the air dehydration membrane is positioned upstream of a carbon bed, which removes hydrocarbon vapors from the process stream. The dehydration membrane therefore prevents degradation of the carbon bed by water.

A bypass line, connected across the air dehydration module, provides an alternative path for the compressed air, and thereby makes it possible to control the proportion of the compressed air stream that passes through the dehydration module. In this way, the degree of dryness of the compressed air stream can be controlled.

The air dehydration membrane used in the present invention is made of a hydrophilic polymer having a permeability for water vapor which is greater than its permeability for air, and wherein the hydrophilic polymer has low selectivity between oxygen and nitrogen. The polymer is coated with another hydrophilic material, which may also be a polymer, the coating being chosen such that the coating does not affect the selectivity of the coated membrane with respect to oxygen and nitrogen, but does increase selectivity of the membrane with respect to water vapor. The membrane is preferably formed as a hollow fiber, and the coating is applied to the bore side of the fiber.

Preferred materials for the hydrophilic polymer used to make the air dehydration membrane include polysulfone and poly ether sulfone. Preferred materials for the coatings include poly vinyl alcohol and Triton X-100.

In one preferred embodiment, the air dehydration membrane used in the present invention is made by forming a polysulfone polymer into a hollow fiber, coating the bore side of the fiber with a solution of poly vinyl alcohol or Triton X-100, and drying the coated fiber. The formation of the fiber is preferably accomplished by mixing polysulfone with a solvent and a non-solvent to form a spin dope, which is then extruded to form the hollow fiber. The solvent and non-solvent are then removed, and the fiber is coated with the polyvinyl alcohol or Triton X-100. The coated fiber is then dried and preferably heat treated.

The present invention therefore has the primary object of providing a method and apparatus for separation of air into components by non-cryogenic means.

The invention has the further object of providing an efficient, non-cryogenic means for drying compressed air before said air enters an air separation module.

The invention has the further object of reducing the cost, and/or improving the efficiency of a membrane-based or PSA-based air separation system.

The invention has the further object of reducing the cost of removing water and water vapor from compressed air streams, in an air separation system.

The invention has the further object of providing a membrane-based technology that permits efficient dehydration of air streams.

The invention has the further object of providing a membrane for air dehydration, wherein the membrane is economically advantageous relative to other membranes of the prior art.

The reader skilled in the art will recognize other objects and advantages of the present invention, from a reading of the following brief description of the drawing, the detailed description of the invention, and the appended claims.

### BRIEF DESCRIPTION OF THE DRAWING

The sole FIGURE in this disclosure provides a schematic diagram of the non-cryogenic air separation system of the present invention, the system including a membrane-based air dehydration module.

### DETAILED DESCRIPTION OF THE INVENTION

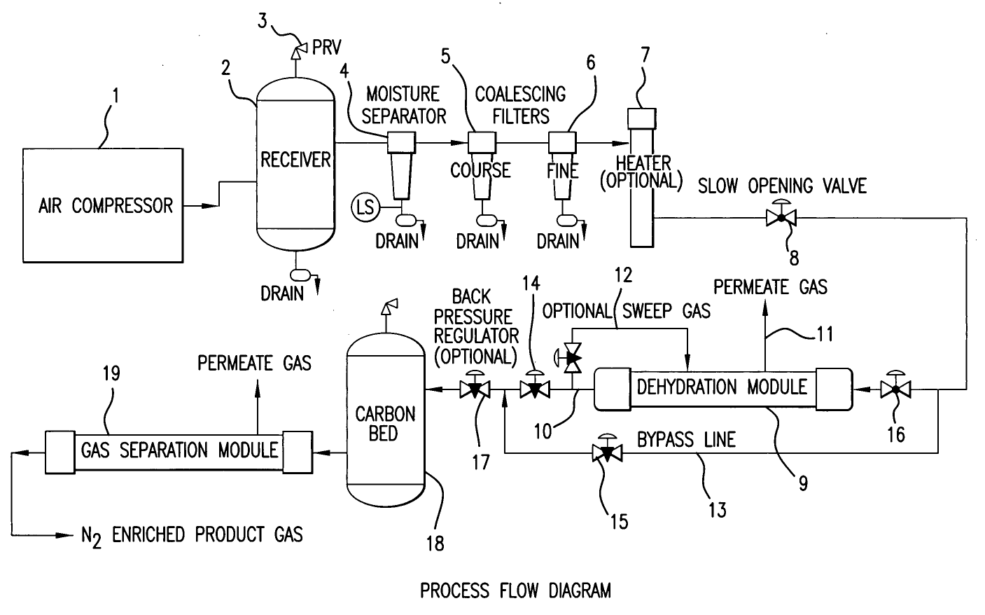

The present invention comprises a non-cryogenic method and apparatus for separating air into components. FIG. 1 provides a schematic diagram showing the essential components of the system.

Ambient air is first compressed by air compressor 1. The compressed air is conveyed into receiver 2, which serves as a buffer between the compressor and the downstream components. The use of the receiver allows the compressor to be turned off briefly, without total loss of pressure in the line. A pressure relief valve 3 prevents unintentional buildup of pressure in the receiver.

Moisture separator 4, and coarse and fine coalescing filters 5 and 6, remove liquid from the compressed air. The liquid to be removed is primarily water, but some liquid oil might also become entrained in the air stream, due to leakage from the compressor motor. Note that the membrane used for air dehydration, discussed below, is not intended for removal of liquid water, but only removes water vapor or other vapors.

Heater 7, which is optional, raises the temperature of the compressed air, further drying it. Slow-opening valve 8, which may be manually or automatically operated, makes it possible to start the system slowly, avoiding a rapid buildup of pressure. The valve is preferably one which requires many turns to open, thereby insuring that the pressure will build gradually.

At least some of the compressed and partially dried air then enters dehydration module 9. The dehydration module includes a polymeric membrane, the composition of which is described in copending U.S. patent application Ser. No. 10/640,363, the disclosure of which is incorporated by reference herein, the composition also being described in detail below. Like any membrane separation unit, the dehydration module defines a sweep gas and a low-pressure permeate gas. In the case of the dehydration membrane, the sweep gas is the relatively dried air, appearing at the output 10 of the dehydration module, and the permeate gas comprises air containing a relatively large proportion of water vapor, appearing at output 11, which in the present case is vented to the outside.

Permeated air or a secondary dry sweep stream may be used to optimize the dehydration process. If the membrane were totally efficient in water separation, all the water or water vapor in the feed stream would be removed, and there would be nothing to sweep it out of the system. As the process proceeds, the partial pressure of the water on the bore side becomes lower and lower, and the pressure on the shell-side becomes higher. This pressure difference tends to prevent additional water from being expelled from the module. Since the object is to make the bore side dry, the pressure difference interferes with the desired operation of the device. A sweep stream may therefore be used to remove the water or water vapor from the bore side, in part by absorbing some of the water, preventing recondensation, and in part by physically pushing the water out. FIG. 1 therefore shows optional sweep gas recycling path 12, which enables some of the product sweep gas to be recombined with the permeate gas. In this case, the permeate gas comprises water vapor, plus whatever gas has passed through the membrane, plus the recycled sweep gas. The above-described recycling step thereby improves the efficiency of the air drying process. Instead of recycling part of the sweep stream, one can provide the sweep gas from an external dry source.

In general, the degree of dehumidification will depend on the partial pressure ratio of water vapor across the dehydration membrane and on the product recovery (the ratio of product flow to feed flow). Better membranes have a high product recovery at low levels of product humidity and/or higher volumetric product flow rates.

Bypass line 13, connected around the air dehydration module, allows some of the compressed air to bypass the module. This arrangement means that only a portion of the air stream flows through the dehydration module. In practice, to protect the gas separation module, it is necessary to reduce the relative humidity only to about 70-90%, though a more preferred relative humidity would be 65% or less. Depending on its construction (i.e. the total effective area of the membrane etc.), the dehydration module is normally capable of producing air having much less humidity than the above. By adjusting the proportion of flow through the module 9 and the bypass line 13, one can produce a product having a desired level of humidity. By making the humidity level no lower than is really necessary, one can limit or reduce the number of component sub-modules required in the dehydration module.

Adjustment of the flow proportions discussed above is accomplished with valves 14 and 15. Valve 16 is used only to isolate the dehydration module from the upstream components, for purposes of maintenance.

The dried compressed air from the dehydration module then passes through optional back pressure regulator 17, through carbon bed 18, and into the gas separation module 19. The back pressure regulator aids in controlling the flow rate of the process stream, and allows the carbon bed and the gas separation module to operate at a different, and lower, pressure from that of the upstream components. The back pressure regulator can be automatically controlled, to regulate the flow of dried compressed air into the gas separation module.

The carbon bed 18 removes oil vapor from the process stream.

The gas separation module 19 can be a membrane system, or a pressure swing adsorption (PSA) system. If a membrane is used, the outputs of module 19 can comprise a nitrogen-enriched product gas and an oxygen-enriched permeate gas. If a PSA system is used, the outputs can also be made to be oxygen-enriched and nitrogen-enriched, depending upon the nature of the adsorbent used. In the case where module 19 uses a gas separation membrane, the latter membrane is, in general, different from the air dehydration membrane in module 9.

The essential component of the air dehydration module 9 is a membrane, or a series of membranes, which is especially efficient in dehumidifying compressed air. This air dehydration membrane is discussed in detail below.

In its most basic form, the air dehydration membrane comprises a porous membrane, preferably having the form of a hollow fiber, the membrane being made of a hydrophilic polymer which has a hydrophilic coating. The polymer is chosen such that its permeability for water vapor is much greater than its permeability for air. Preferably, the polymer is such that it still allows air to flow through it, and does not show appreciable selectivity for oxygen relative to nitrogen. The coating is chosen such that the coating does not affect the selectivity of the overall fiber for oxygen and nitrogen, but does increase the selectivity of the fiber for water vapor. The coating may itself be a polymeric material, and preferably has a high molecular weight and a high boiling point.

In one preferred embodiment, the air dehydration membrane is a surfactant-coated polysulfone hollow fiber membrane, or a poly vinyl alcohol-coated polysulfone membrane, or a poly vinyl alcohol-coated poly ether sulfone membrane. All of the coatings are applied on the bore side of the membrane.

The air dehydration membranes used in the present invention achieve the selective removal of water vapor while not significantly altering the relative concentrations of oxygen and nitrogen found in the feed stream.

As indicated in the drawing, the air dehydration membrane used in the present invention can be provided as part of a module into which water vapor (saturated or near saturated) and compressed air are introduced. The module produces a dry pressurized product stream (typically having an oxygen concentration within about 1% of 20.9%) and a low pressure permeate stream. The permeate stream contains a mixture of air and the bulk of the water vapor introduced into the module.

The air dehydration membranes used in the present invention are easily made at low cost, and can outperform existing commercial membranes in either volumetric productivity or product recovery.

The air dehydration membrane used in the present invention can be spun into a fiber using the techniques described in U.S. Pat. No. 4,772,392, the disclosure of which is incorporated by reference.

The following examples illustrate the manufacture of the air dehydration membranes used in the present invention.

### EXAMPLE 1

Polysulfone polymer (product number UDEL P-1835, obtained from Solvay Plastics) was combined with tri-ethylene glycol (TEG) and n-methyl-pyrrolidinone (NMP) to form a spin dope that was extruded through a multi-filament hollow fiber die. The range of ratios of solvent (NMP) to non-solvent (TEG) can be from about 2.0 to about 4.0, with 2.5 being the preferred ratio. The polymer concentration range can be from about 40 to about 65% by weight, with 50% by weight being the preferred concentration. Die temperatures can range from about 75° C. to about 110° C., with 90° C. being the preferred spin temperature. Blowing a core gas through the center of an annular ring die forms the hollow fiber profile. The flow rate of the core gas can range from about 15 to about 30 SCCM, with 24 SCCM being preferred in order to achieve the desired fiber size of about 280 to about 350 microns for the outer diameter, and about 200 to about 250 microns for the inner diameter.

After the fiber was formed as described above, the fiber exited the spin die and was passed through 1) a controlled atmosphere quench zone, 2) a cold quench, and 3) a hot leach, after which the fiber was taken up onto a core.

The quench zone (or “draw zone”) uses a quench cabinet to control quench air flow rate, temperature, and humidity. Air flow rates of about 2 to about 7 SCFM are used, with 4 SCFM being preferred. The temperature range is about 5° C. to about 25° C., with 12-15° C. being preferred. The humidity range is about 35% to about 90% relative humidity, with 80% relative humidity being preferred.

After passing through the quench or draw zone, the fibers entered a low temperature water bath, which comprises the cold quench. This bath sets the fiber and starts the process whereby the entrained solvent and non-solvent are leached out. The temperature range for this low temperature bath is about 3° C. to about 15° C., with 4.5° C. being preferred. The residence time in the quench bath is less than about 0.5 seconds.

The fiber next passed through a hot water leach bath where a majority of the remaining solvent/non-solvent was removed. The temperature range for the hot water leach bath is about 75° C. to about 90° C. with 80° C. being preferred. The residence time in this bath was less than about 2 seconds. The leach bath includes two sets of driven rollers, wherein each set of rollers can be made to rotate at a different speed. Operating the second, or exit, set of leach bath rollers at a higher speed than the first set allows the fibers to be tensioned or stretched to varying degrees. The speed differential of the rollers used in making the present fiber can range from about 0% to about 20%, with 10% being preferred. The organic levels in both baths (quench and leach) can range from about 0% by weight to about 1% by weight, with a percentage of less than about 0.5% by weight being preferred.

After passing through the leach bath, the fibers were then taken up onto a typical textile fiber core to await further processing. The fibers may then be woven into a fabric, using a loom, and arranged in modules, as is fully described in U.S. Pat. No. 5,598,874, the disclosure of which is incorporated by reference.

Following the weaving process, the fiber was potted into a test module that allows for the pressure isolation of the bore side of the fiber from the shell-side of the fiber. This potting process was done through the use of an epoxy resin to form two tubesheets at either end of the fiber bundle.

The fibers of the test module were then coated with a solution, in water, of 4% PVA (Poly vinyl alcohol, 98-99% hydrolyzed, 31,000-50,000 Mw, supplied by the Aldrich Chemical Company). The coating solution was prepared by first weighing out the PVA and water and then heating the mixture to about 80-90° C. for about 2-3 hours, to allow the PVA to dissolve. Once dissolved, the solution was filtered and cooled to near room temperature. The solution was then passed through the module on the bore side at 0 to 25 psig. The module was then air dried by passing air through the bore of the fibers.

Once dried, the module can be tested for air dehydration properties. To give enhanced durability, the module is heat treated to about 80-85° C. for 5 hours, to crystallize the PVA coating and make it insoluble in water. The coating, drying and heat treatment process may be repeated to give improved performance.

The fiber made according to this Example has an oxygen/nitrogen selectivity of 0.92, which indicates the presence of knudsen flow. The fiber has pores which have dimensions of the order of 10-100 angstroms, which inference is based on the observation that one sees knudsen flow for oxygen and nitrogen. The fiber is also hydrophilic, with a high permeability for water vapor relative to its permeability to air.

### EXAMPLE 2

The process of Example 1 was repeated with an ultrafiltration fiber obtained from the Hydranautics Corporation. This fiber is commercially available, and is sold under the trademark HYDRACAP. The fiber has been used for water purification processes, and is categorized as a UF (ultrafiltration) membrane of Hydranautics Corp. The fiber is made of poly ether sulfone, instead of polysulfone. The fiber is quite large, having an outside diameter of 0.049 inches.

The fiber used in this Example is porous and hydrophilic, and has essentially no selectivity between oxygen and nitrogen. It has a high water vapor permeability relative to its permeability to air. Its pores have a size of the order of 100 to 1000 angstroms.

The fibers used in this Example are initially impermeable to air with no discernible air dehydration properties. The fiber must first be flushed with pressurized water to remove the water soluble pore filling material that is used in the storage of the fiber. Then the membrane can be air dried and tested for gas permeation properties. The water rinse step and air drying step were therefore conducted prior to the step of coating the fiber with PVA. The steps in this Example were otherwise the same as described in Example 1.

For both Example 1 and Example 2, the fiber was made of a membrane formed from a hydrophilic polymer having relatively little or no selectivity between oxygen and nitrogen. Both polymers have a high permeability for water vapor compared to their permeability for air.

The following Example describes the results of tests performed on modules made with the fibers produced in Examples 1 and 2, to evaluate their air dehydration properties.

### EXAMPLE 3

Test devices were constructed to test the coated fibers described in Examples 1 and 2. The fibers were contained in copper tubing that was 38 inches long and 0.375 inches in diameter. The copper tubing had brass fittings at either end, with two fittings parallel to the module for connecting with the bore side of the fibers, and two fittings perpendicular to the fiber inset from tubesheets that connect to the shell-side of the fibers. Tubesheets at either end of the device were made with epoxy resins that, when cured, separated the bore side of the membranes from the shell-side. The latter arrangement allows for the isolated pressurization of either side of the membrane. The fibers made according to Example 1 had an outside diameter of 220 microns, and the test device used 180 fibers. These fibers are highly porous. The fibers used in Example 2 were much larger (having an outside diameter of 0.049 inches), and the test device contained only 6 such fibers. All test results are based on bore side pressurization and counter-current flow between the feed air and the resultant permeate flow.

The following Table I summarizes the performance of the fiber used in Example 2. The table shows the results obtained when the fiber has been flushed with water and dried, as described above. In Test No. 1, there was no coating of PVA. A single coating of PVA was used in Test Nos. 2-5, and a double coating of PVA was used in Test Nos. 6-9.

TABLE I
Fiber of Example 2, Evaluated at 100 psig
with 75° F. Pressure Dewpoint Air

| | | | Permeate | | Product |
|---|---|---|---|---|---|
| | | | Atmos- | | Atmos- |
| | | | pheric | | pheric |
| Test | Coating/ | Permeate | Dewpoint | Product | Dewpoint |
| Number | Treatment | Flow | (° F.) | Flow | (° F.) |
| 1 | None | 1.2 cfm | 30 | 1.2 cfm | 30 |
| 2 | 4% PVA | 1.13 lpm | 53 | 7 lpm | −3 |
| 3 | 4% PVA | 1.18 lpm | 43.3 | 3.4 lpm | −9.5 |
| 4 | 4% PVA | 1.2 lpm | 36 | 2.25 lpm | −21 |
| 5 | 4% PVA + | 1.5 lpm | 50 | 5.7 lpm | −3 |
| | 80° C. | | | | |
| | for | | | | |
| | 5 hours | | | | |
| 6 | Second 4% | .32 lpm | 61 | 2.06 lpm | 0 |
| | PVA Coating | | | | |
| 7 | Second 4% | .33 lpm | 53 | 1.36 lpm | −23 |
| | PVA Coating | | | | |
| 8 | Second 4% | .33 lpm | 44 | .73 lpm | −54 |
| | PVA Coating | | | | |
| 9 | Second 4% | .33 lpm | Not | .52 lpm | <−64 |
| | PVA Coating | | tested | | |

Test No. 1 was conducted with a test device provided by Hydranautics Corporation, the device being about 9 inches long and containing about 25 fibers. Test No. 1 was conducted at only 20 psig. The remaining tests shown in the table were conducted using the test device described in Example 3.

Table I shows that, without the PVA coating, the fiber did not exhibit any air dehydration properties. But the fiber that was coated exhibited a high degree of dehydration. The degree of dehydration was high with one coat, and even higher with two coats. In all cases the oxygen level in the product gas was 20.9%, indicating no selectivity between oxygen and nitrogen for this fiber. Note that Test No. 5 included coating with PVA plus heat treatment at 80° C. for five hours.

The following Table II summarizes the performance of the fiber used in Example 1. Unlike the fiber used in Example 2, the fiber used in Example 1 was air permeable after the fiber fabrication process. In addition to PVA coatings, the fiber was tested with a coating of Triton X-100 to improve the air dehydration properties of the fiber. Triton X-100 is a non-ionic surfactant sold by Aldrich Chemical Company, under the product number 23,472-9. In the examples described herein, it was prepared in the form of a solution in water having a concentration of 150 ppm, and was coated in this form onto the fiber.

TABLE II
Fiber of Example 1, Evaluated at 100 psig
with 75° F. Pressure Dewpoint Air

| | | | Permeate | | Product |
|---|---|---|---|---|---|
| | | | Atmos- | | Atmos- |
| | | Permeate | pheric | Product | pheric |
| Test | Coating/ | Flow | Dewpoint | Flow | Dewpoint |
| Number | Treatment | (lpm) | (° F.) | (lpm) | (° F.) |
| 1 | Triton | 14 | 13 | 3 | <−64 |
| | X-100 | | | | |
| | (150 ppm) | | | | |
| 2 | 4% PVA | 5.5 | 33 | 6.4 | <−64 |
| 3 | 4% PVA | 5.1 | 41.6 | 7.5 | −35 |
| 4 | 4% PVA + | 5.2 | Not | 7.6 | −37 |
| | 80° C. | | Tested | | |
| | for 5 hours | | | | |
| 5 | Second 4% | 6.2 | Not | 10.6 | <−64 |
| | PVA Coating | | Tested | | |
| 6 | Second 4% | 5.7 | 40 | 12.8 | −36 |
| | PVA Coating | | | | |
| 7 | Second 4% | 5.4 | 22 | 11.3 | −54 |
| | PVA Coating | | | | |
| 8 | Second 4% | 5.2 | 45 | 12.5 | −30 |
| | PVA Coating + | | | | |
| | second | | | | |
| | 80° C. | | | | |
| | for 5 hours | | | | |

Table II shows that both the Triton X-100 and the PVA coatings were effective in achieving excellent air dehydration properties. Oxygen levels in the dried product gas were measured to be in the range of about 21.6% to 21.9%, indicating that the air permeation was primarily due to knudsen flow, where the oxygen/nitrogen selectivity is about 0.92.

The following Table III compares the results obtained with air dehydration membranes used in the present invention, with those obtained from commercially available dehydration membranes of the prior art.

The efficiency and productivity of the air dehydration membranes used in the present invention were compared with those of existing membrane dehydrators obtained from Hankison International. In particular, the membranes used in the present invention were compared with published data for the Hankison HMD20-2 module, operated at 100 psig with 80° F. pressure dewpoint inlet air. The efficiency was defined as the ratio of the dry product gas flow to that of the inlet feed flow at various product dewpoints. The relative productivity is defined by the product flow rate for a given volume of device.

Since the test devices described above were smaller than the commercial devices, the test results were scaled to correspond to the size of the HMD20-2 device, which is 26.4 inches long and 2.1 inches in diameter. The scaling was done by taking a ratio of the fiber surface area in the test devices described above, to the surface area available to the fiber in the Hankison casing.

In comparing these devices, it was assumed that there was a 50% packing factor for the fiber, and that the inside casing diameter of the HMD20-2 device is about 1.7 inches, and that the active length of the fiber (i.e. the length of the module less the length of the tubesheets) was about 22 inches.

For the fiber made according to Example 2, with an outside diameter of 0.049 inches, one can fit 625 fibers into a module having a size comparable to that of the Hankison HMD20-2 module. Taking this fact into account, and also taking into account the change in length from 38 inches to 22 inches, one obtains a scaling factor for the flow of 60.

For the fiber made according to Example 1, the calculated fiber count is 19500, which yields a scaling factor of 62 for estimated product flow for a module having a size similar to the HMD20-2 device.

TABLE III
Comparison of Results of the Present Invention
with Results Obtained from Commercially Available
Hankison Membrane Dryers
100 psig, 80° F. Pressure Dewpoint

| | | | Coated | | Coated | |
|---|---|---|---|---|---|---|
| | | | Fiber | Coated | Fiber | Coated |
| | | | from | Fiber | from | Fiber |
| | Hankison | Hankison | Ex. 2 | from | Ex. 1 | from |
| Atm | HMD20-2 | HMD20-2 | (Scaled | Ex. 2 | (Scaled | Ex. 1 |
| DP | Product | Product | Product | (Product | Product | (Product |
| (° F.) | Flow | Recovery | Flow) | Recovery) | Flow) | Recovery) |
| 0 | 3.8 | 83% | 4.4 | 86.5% | | |
| −18 | 2.7 | 77% | 2.9 | 80.5% | | |
| −35 | 2 | 71% | | | 28 | 69% |
| −54 | 1.6 | 67% | 1.5 | 69% | 24.7 | 67.5% |
| <−64 | 1.4 | 66% | 1.1 | 61% | 23 | 63% |

The flows shown in Table III are in scfm. The first column shows the desired dewpoint. The flows used for the Hankison device are based on data provided by Hankison sales literature. The tests of the fiber made according to the present invention were scaled for meaningful comparison with a module having a size corresponding to the Hankison HMD20-2 product. The product recovery is the percentage of the feed flow that becomes dry product air.

Examination of Table III shows that the dehydration membranes used in the present invention, in all cases but one, yield results that are superior to those of the prior art. In particular, the membrane made according to Example 1 showed nearly the same product recovery percentages as the prior art, but had substantially greater product flow. The membrane made according to Example 2 showed product recovery percentages and product flows that were, in all cases but one, greater than that obtained from the prior art material. The only exception was the case where the desired dewpoint was <−64° F.

The following is a discussion of the physical mechanisms believed to underlie the operation of the dehydration membranes used in the present invention. However, the invention should not be deemed limited by the following explanation.

It is believed that air and water vapor pass through the dehydration membrane used in the present invention by three different means.

For water vapor penetration, the relevant mechanisms are:
1) permeation through the dense polymer;
2) viscous flow through the pores; and
3) knudsen flow through the very fine pores.

The permeation through the dense polymer is believed to be the dominant factor for water vapor penetration.

For air penetration, the relevant mechanisms are:
1) permeation through the dense polymer;
2) viscous flow through the pores; and
3) knudsen flow through the very fine pores.

The permeation through the dense polymer is believed to be a minor factor. The viscous flow through the pores is believed to be the dominant factor for the fiber of Example 2, and the knudsen flow through the very fine pores is believed to be dominant for the fiber of Example 1.

It appears that the permeation through the dehydration membrane (either for water vapor or for air) is not greatly impacted by the coatings applied to the membrane. The viscous pore flow and the knudsen flow are lowered by the coatings, however. The coatings therefore serve to improve the dehydration properties of the membrane because the water vapor permeation is dominated by permeation through the dense polymer, which is unchanged by the coating, while the permeation of air is lowered because its rate is dependent on the viscous flow and knudsen flow which are both lowered by the coating, and since the permeation through the polymer is insignificant for air.

The use of the air dehydration module described above, in the gas separation system of the present invention, allows operation at near ambient temperature. At these temperatures, the air separation module will last longer and operate with typically 10-35% greater efficiency, depending on temperature and pressure, as defined by the amount of enriched-nitrogen product obtained relative to the quantity of feed air required. Since the air dehydration modules will typically purge 8-12% of the feed flow, the overall efficiency gain for the system typically will be 5-25%. This means that in a system using the air dehydration modules as a pretreatment for air separation modules, one may use a smaller feed compressor, for many applications.

The reader skilled in the art will recognize that the invention can be modified in various ways. The dehydration membrane can be provided in various shapes and sizes. Materials other than those specifically described may be used, as long as they satisfy the physical criteria set forth above. These and other similar modifications should be deemed within the spirit and scope of the following claims.

1. A system for separation of air into components, comprising:
a) means for compressing ambient air,
b) means for removing liquid water from the compressed air, the removing means being connected to an output of the compressing means,
c) an air dehydration membrane for removing water vapor from the compressed air, the air dehydration membrane being connected to an output of the removing means, and
d) a gas separation module connected to an output of the air dehydration membrane.

2. The system of claim 1, wherein the air dehydration membrane comprises a hydrophilic polymer having a permeability for water vapor which is greater than its permeability for air, said hydrophilic polymer also showing low selectivity between oxygen and nitrogen, the polymer having a hydrophilic coating, wherein the coating is chosen such that the coating does not affect the selectivity of the coated membrane with respect to oxygen and nitrogen, but does increase selectivity of the membrane with respect to water vapor.

3. The system of claim 2, wherein the hydrophilic polymer is selected from the group consisting of polysulfone and poly ether sulfone.

4. The system of claim 2, wherein the coating is selected from the group consisting of poly vinyl alcohol and Triton X-100.

5. The system of claim 3, wherein the coating is selected from the group consisting of poly vinyl alcohol and Triton X-100.

6. The system of claim 2, wherein the membrane has the form of a hollow fiber.

7. The system of claim 6, wherein the fiber has a bore side and a shell side, and wherein the coating is formed on the bore side.

8. A system for separation of air into components, comprising:
a) means for compressing ambient air,
b) means for removing liquid water from the compressed air, the removing means being connected to an output of the compressing means,
c) an air dehydration membrane for removing water vapor from the compressed air, the air dehydration membrane being connected to an output of the removing means, the air dehydration membrane comprising a hydrophilic polymer selected from the group consisting of polysulfone and poly ether sulfone, and
d) a gas separation module connected to an output of the air dehydration membrane.

9. The system of claim 8, wherein the hydrophilic polymer has a coating which is selected from the group consisting of poly vinyl alcohol and Triton X-100.

10. A method for separation of air into components, comprising:
a) compressing ambient air, to form a compressed air stream,
b) removing liquid water from the compressed air stream,
c) passing the compressed air stream through an air dehydration membrane which removes water vapor from the compressed air stream, and
d) directing a dried compressed air stream from the air dehydration membrane into a gas separation module, and
e) withdrawing a nitrogen-enriched stream and an oxygen-enriched stream from the gas separation module.

11. The method of claim 10, further comprising selecting the air dehydration membrane to be a hydrophilic polymer having a permeability for water vapor which is greater than its permeability for air, said hydrophilic polymer also showing low selectivity between oxygen and nitrogen, the polymer having a hydrophilic coating, wherein the coating is chosen such that the coating does not affect the selectivity of the coated membrane with respect to oxygen and nitrogen, but does increase selectivity of the membrane with respect to water vapor.

12. The method of claim 11, further comprising selecting the hydrophilic polymer to be from the group consisting of polysulfone and poly ether sulfone.

13. The method of claim 11, further comprising selecting the coating from the group consisting of poly vinyl alcohol and Triton X-100.

14. The method of claim 12, further comprising selecting the coating from the group consisting of poly vinyl alcohol and Triton X-100.

15. A method for separation of air into components, comprising:
a) compressing ambient air, to form a compressed air stream,
b) removing liquid water from the compressed air stream,
c) passing the compressed air stream through an air dehydration membrane which removes water vapor from the compressed air stream, the air dehydration membrane being selected from the group consisting of polysulfone and poly ether sulfone, and
d) directing a dried compressed air stream from the air dehydration membrane into a gas separation module, and
e) withdrawing a nitrogen-enriched stream and an oxygen-enriched stream from the gas separation module.

16. The method of claim 15, further comprising coating the air dehydration membrane with a material selected from the group consisting of poly vinyl alcohol and Triton X-100.
